(19) United States
(12) Patent Application Publication
(10) Pub. No.: US 2020/0306777 A1
(43) Pub. Date: Oct. 1, 2020

(54) PORTABLE PRESSURIZED FLUID DISPENSER

(71) Applicant: Meera Mohammed Byaat Batawil Almazrouei, Abu Dhabi (AE)

(72) Inventor: Meera Mohammed Byaat Batawil Almazrouei, Abu Dhabi (AE)

(21) Appl. No.: 16/760,946

(22) PCT Filed: Nov. 2, 2017
(86) PCT No.: PCT/IB2017/056811

§ 371 Date: May 1, 2020

(51) Int. Cl. B05B 9/08

(52) U.S. Cl. CPC B05B 9/0888; B05B 9/0805

(57) ABSTRACT

The invention relates to a pressurised vessel for holding a fluid to be dispensed under pressure. The vessel includes a chamber for receiving the fluid and the pressurized delivery fluid, such as compressed air. The vessel is intended to be portable and includes a means for handling the vessel, additionally the vessel may be mounted to a manual surface engaging unit for transporting the vessel. Such unit may include a wheeled arrangement or sliding arrangement, such as ski's.

### FIELD OF THE INVENTION

The invention relates to a pressurised vessel for holding a fluid to be dispensed under pressure. The vessel includes a chamber for receiving the fluid to be dispensed and the pressurized delivery fluid, such as compressed air. Further, the vessel is intended to be portable and non-reliant on an external power source or fuel driven engine.

### BACKGROUND OF THE INVENTION

The need for a portable pressurized water source is common in cleaning operations, such as washing an automobile or the exterior surface of windows in a building. Typically, the need for the water source is required where the object to be cleaned is too large to bring to a water source, or the object is immovable. In such circumstances the water source is brought to the object. A pressurized water source is also required when normal cleaning techniques need improvement, this is typically the case when dealing with high pressure sprays for cleaning vehicles, or for cleaning larger surfaces such as walkways and driveways, where the force of the pressure will aid in the cleaning process.

The need for a pressurized water spray is normally met by a fluid dispenser which includes an electric compressor, connected to a main power supply. The compressor draws in, and compresses, the surrounding air which is fed into the device and used as working fluid to place the water under high pressure. The high pressurized fluid is then sprayed from the device as needed.

Situations exist where the electric compressor arrangement cannot be used, most typically, where there does not exist a main power supply. Such as for outdoor camping, exterior window cleaning, or even where a vehicle to be cleaned cannot be brought close enough to the electrically powered device.

An alternative to an electrically powered compressor arrangement is an engine driven arrangement. A particular drawback of this approach is the additional machinery and fuel which must also be transported with the high-pressured device.

### OBJECT OF THE INVENTION

It is an object of the current invention to address the above mentioned problems, at least to a degree, by providing a portable high pressurized fluid dispensing device which does not require the need for electrically or engine driven compression arrangement, which device is of a low cost and is convenient to use.

### SUMMARY OF THE INVENTION

In accordance with the invention there is provided a portable unit for dispensing fluid at pressure, which includes;

a vessel having a chamber, for receiving a fluid to be dispensed and a delivery fluid at pressure, and a valve for providing passage between an exterior and an interior of the chamber;

a port formed through the vessel to the chamber;

a hose arrangement connected through the port, in communication with the chamber; and

a check valve positioned along the hose;

wherein opening of the check valve provides a release of the fluids held in the chamber.

The vessel may be a gas cylinder; further for the vessel to be a repurposed gas cylinder; further still for the vessel to be refillable.

The valve may be a tyre valve; further still the tyre valve may be a valve used for inflating and deflating a vehicle's tyres; further still for the tyre valve to introduce a delivery fluid for pressurizing the chamber.

The port may introduce a fluid, to be dispensed, into the chamber; further for the port to include a mating arrangement for connecting the hose.

The invention provides further for the hose to include a nozzle; for the nozzle to include a diffuser to spray a jet of fluid passing therethrough; for the nozzle to be in the form of a spray and trigger arrangement; further still for the check valve to be actuated by the trigger.

The invention provides further for the vessel to include a regulator, positioned at an end of the hose for connecting the hose to the port; further still for the regulator to be in the form of a stopcock.

The invention provides further for a means for handling the unit; further where the means may be a handle; further still where the means may be at least one tethered strap; even further still where the means may be a handle and at least one tethered strap.

The invention provides further for the vessel to be enclosed in a protective cover; further where the cover may be an empty body with a mouth to provide access to an inside of the body; further still for the body to have a lid for opening and closing the mouth; further for the vessel to be accessible through the mouth; further still for the body to include at least a first opening for the hose to pass through; still more further for the body to include a second opening for the valve to pass through; further still for the body to be formed of Perspex™.

The invention provides further for the unit to be mounted to a manual ground engaging arrangement for transporting the vessel; further for the arrangement to be a wheeled arrangement; further still for the arrangement to be a sliding arrangement.

### BRIEF DESCRIPTION OF THE DRAWINGS

These and other features of the invention will become more apparent by the following description of the embodiments, which are made by way of example, with reference to the accompanying drawings in which:

FIG. 1 shows a view, in perspective, from the front of a portable pressurized fluid dispenser unit in accordance with the invention;

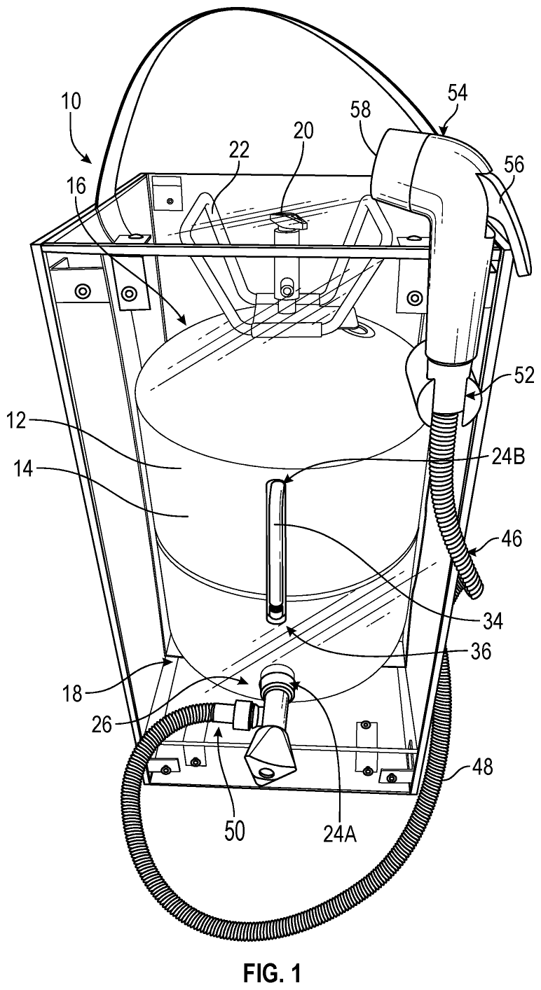

FIG. 2 shows a view, in perspective, from the rear of the unit of FIG. 1; and

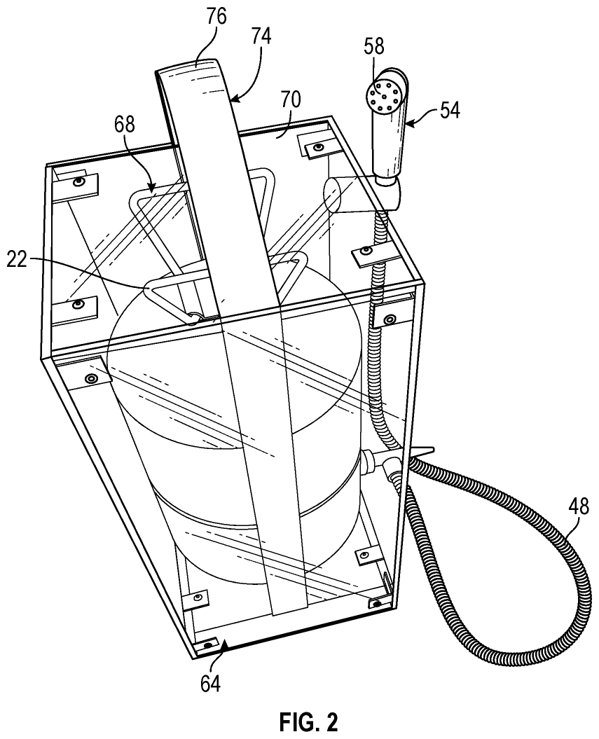

FIG. 3 shows a view, in perspective, from above of the unit of FIG. 1.

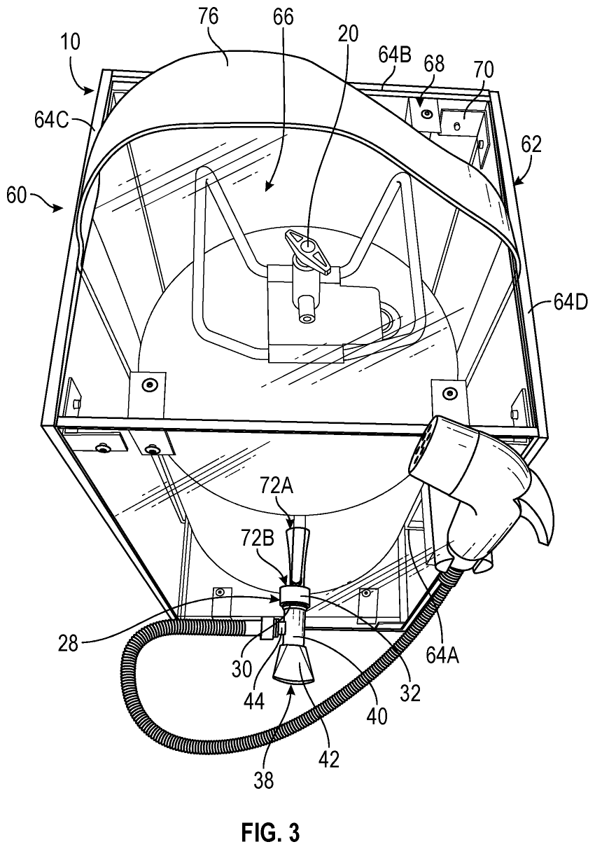

### BRIEF DESCRIPTION OF THE PREFERRED EMBODIMENTS

Referring to the Figures which show a portable pressurized fluid dispenser unit 10 in accordance with the invention. The unit includes a vessel 12, which houses a chamber (not shown). The vessel includes a sidewall 14 which extends between an upper end 16 and a lower end 18.

A repurposed gas cylinder forms the vessel 12 of the invention. The cylinder is shown to include the original tap 20 and handle 22. In the original use of the cylinder the tap provided a sealable means for controlling the passage of gas into, and out of, the chamber. The tap and the handle do not form part of the current invention, but are merely shown for completion purposes.

Prior to forming the unit 10, the vessel 12 is completely drained of any gases or fluids. This is achieved by opening tap 20 and allowing the vessel to stand for a suitable amount of time. During this standing period, any gases or fluids within the chamber flow out and into the atmosphere. Only once the vessel is completely drained will the steps required in forming the unit take place.

Two apertures 24A and 24B are formed through the sidewall 14. Each aperture extends through the sidewall and into the chamber. The apertures are formed by use of an electric drill or other suitable means for creating an aperture through the vessel.

The first of the two apertures, 24A, is in the form of a port 26. The port includes a mating arrangement machined into an inner circumference of the port. The mating arrangement is commonly a female thread, but may include a bayonet type design.

Port 26 may additionally, or alternatively, include a connector 28 for providing the mating arrangement. The connector includes a hollow elongate body (not shown), which is passed through the port and extends into the chamber, a trailing end 30, which includes a threaded arrangement on an outer circumference on the elongate body, and a compression ring 32, engageable with the thread.

The trailing end 30 is formed in a tapering fashion, where the outer circumference increases in diameter from the trailing end toward the elongate body.

The elongate body is affixed in the port 26 by any technique known in the art. An example of such a technique would be to glue the body in the port. The fixing is done so as to provide an airtight seal between the body and the port.

The hollow body effectively provides the port into and out of the chamber. The ring 32 is aligned with trailing end 30 and fed over the thread. Feeding the ring further along the thread causes the trailing end to reduce in diameter. The reduction is caused by the ring, which is non-deformable, passing over the increasing diameter of the trailing end. The reduction in diameter results in a closing force to be applied to an object placed in the hollow body of the connector.

The port 26 is provided as an inlet and outlet port. Filling of the vessel 12 with a fluid to be dispensed, such as water, will take place through the port. Additionally, the dispensing of the fluid takes place by the fluid passing out of the chamber, through the port.

The second of the two apertures 24B extends through the sidewall 14. Aperture 24B provides passage between an exterior and an interior of the chamber.

The aperture is appropriately sealed by valve arm 34 and valve 36. The sealing is such, that the passage between the exterior and interior of the chamber extends through the valve arm and valve, respectively.

The sealing may be done by any technique known in the art, such as gluing.

Valve 36 is installed to allow movement of a fluid from an exterior to the interior of the chamber, but to resist the reverse movement of the fluid. A delivery fluid, commonly compressed air which is used to compress the chamber, is passed through the valve.

The valve 36 is a tyre valve, i.e. the same type of valve used for filling a vehicle's tyres with compressed air. The valve is thus compatible with the nozzle of a compressed air source found at most, if not all, vehicle fuel stations, petrol stations or garages.

In the embodiment, unit 10 additionally includes a regulator 38, in the form of a stopcock.

The regulator 38 includes a body 40, having a central bore, a head 42, for opening and closing the central bore, and a spout 44, for directing fluid passed through the central bore.

The regulator 38 is positioned and affixed to connector 28. The body 40 is passed through compression ring 32 and into the elongate body of the connector. The ring is aligned and fed along the thread of the elongate body to compress around the regulator. The regulator is then held in place and a seal is provided.

The ring 32 may be unfed from the elongate body, so to release the regulator 38. This will provide access for refilling of the vessel 12.

Included with the unit 10 is a hose 46. The hose includes an elongate flexible body 48 having a first end 50 and a second end 52.

In Figures, the first end 50 is shown coupled to spout 44.

Positioned along the flexible body 48 is a check valve (not shown). The check valve will provide passage for unidirectional flow of a fluid passing through the hose.

Located toward the second end 52 is a nozzle 54 and trigger 56.

The nozzle 54 includes a diffuser 58. The diffuser results in a jet of fluid passing through the nozzle to be ‘sprayed’ as the fluid diffuses through the apertures.

The trigger 56 is associated with the check valve. The association is such that movement of the trigger, will actuate the check valve between a closed position, where fluid is retained, to an open position, where fluid is released.

The invention does provide for the first end 50 to be coupled to connector 28, or even port 26. In such cases the regulator 38, and/or the connector 28 is not be required.

The vessel 12 is enclosed in a protective cover 60. The cover is rectangular in shape and includes a body 62 having a base 64, sidewalls 64A, 64B, 64C and 64D respectively, which extend substantially vertically from the base and enclose an inside region 66. A mouth 68 provides access to the region 66. The body additionally includes a lid 70, which may be manipulated, for opening and closing of the mouth.

Sidewall 64A includes two holes 72A and 72B. The first of the two holes, 72A is shaped to allow the valve arm 34 and valve 36 to project through the wall 64A. The second of the two holes 72B allows the regulator 38 to be connected to the port 26 (or connector 28) through the wall.

The vessel 12 is placed within the region 66 through the mouth 68. Access to the vessel is also provided through the mouth. The vessel is placed so as to align the valve arm 34 and valve 36 with the first hole 72A, and to align the port 26 (and connector 28) with the second hole 72B.

The protective cover 60 acts as a shield to limit damage or injury to a user, should the vessel 12 malfunction. Such a malfunction could include a fluid leak, or even explosion of the vessel itself.

The cover 60 is formed of a sturdy material, which in the current embodiment is Perspex™. The invention is not deemed to be limiting in this regard, and the cover could be formed of a steel, wooden, or metallic material, or such other sturdy material.

A means 74 for handling the unit 10 is shown. The means may be a handle, or may include one or more tethered straps 76.

A manual ground engaging arrangement (not shown) may accompany the unit 10. Such an arrangement may include a wheeled arrangement, or a sliding arrangement. The arrangement would be ideally located toward the base 64.

In use of the invention, a unit 10 as described above and as shown in the Figures is provided. The unit must be filled and compressed before the function, for which this application is made, may become possible.

In order to fill the vessel 12 and chamber with a fluid to be dispensed, the port 26 must be opened. In light of the different embodiments possible with the invention, opening port 26 may include uncoupling regulator 38. This would be achieved by loosening compression ring 32 of the connector 28. In an alternative embodiment, the first end 50 of the hose 46 would have to be uncoupled from the connector.

The fluid to be dispensed is then passed into the chamber through port 26, until the volume of fluid within the chamber is approximately 50% of the total volume of the chamber. The port is then sealed again by re-coupling the regulator 38 (or second end 50).

Head 42 is manipulated to close the off the central bore of the regulator 38.

A delivery fluid, commonly compressed air, is then passed through valve 36 and into the chamber. This is made possible by using the compressed air source discussed above, and coupling it to the valve. The compressing process is stopped once enough air is passed into the chamber, to sufficiently pressurize the chamber.

Head 42 is manipulated to open the central bore of the regulator 38.

The increased pressure within the chamber will force the fluid to be dispensed and the delivery fluid through the regulator 38 and into the flexible body 48. The fluids will travel the length of the body until it reaches the check valve.

A user may then handle the nozzle 54 and direct it toward an object to be sprayed with the fluid. The user may depresses trigger 56, which actuates the check valve and allows the fluid to pass through the nozzle and into the diffuser 58. The fluid is then sprayed out of the diffuser over the object as per the invention.

The increased pressure within the chamber, on account of the delivery fluid, will drive both the fluid to be dispensed, and the delivery fluid, out of the chamber and through the hose and nozzle. Once the pressure within the chamber equals the pressure outside of the chamber or if the fluids within the chamber are exhausted, the driving force will stop. The unit 10 will then need to be refilled as described.

A person skilled in the art will appreciate that a number of variations may be made to the above described invention or features thereof, without departing from the scope of the present invention.

1. A portable unit for dispensing fluid at pressure which includes;
a. a vessel, having;
i. a chamber, for receiving a fluid to be dispensed and a delivery fluid at pressure; and
ii. a valve, for providing passage between an exterior and an interior of the chamber;
b. a port, formed through the vessel to the chamber;
c. a hose arrangement connected through the port, in communication with the chamber; and
d. a check valve positioned along the hose;
wherein opening of the check valve provides a release of the fluids held in the chamber.

2. A unit as claimed in claim 1 wherein the vessel is a gas cylinder.

3. A unit as claimed in claim 1 wherein the vessel is a repurposed gas cylinder.

4. A unit as claimed in claim 1 wherein the valve is a tyre valve.

5. A unit as claimed in claim 1 wherein the hose includes a nozzle having a diffuser and a trigger.

6. A unit as claimed in claim 5 wherein the trigger actuates the check valve.

7. A unit as claimed in claim 1 which includes a regulator, positioned at an end of the hose, for connecting the hose to the port.

8. A unit as claimed in claim 7 wherein the regulator is a stopcock.

9. A unit as claimed in claim 1 which includes a means for handling the unit.

10. A unit as claimed in claim 9 wherein the means is a handle.

11. A unit as claimed in claim 9 wherein the means is at least one strap.

12. A unit as claimed in claim 1 which includes a protective cover.

13. A unit as claimed in claim 12 wherein the cover includes an empty body with a mouth, for providing access to an inside of the body, and a lid for opening and closing the mouth.

14. A unit as claimed in claim 12 wherein the cover includes a first opening, for the hose to pass though, and wherein the body includes a second opening, for the valve to pass through.

15. A unit as claimed in claim 12 wherein the cover is formed from Perspex™.

16. A unit as claimed in claim 1 which includes a manual ground engaging arrangement for transporting the vessel.

17. A unit as claimed in claim 16 wherein the ground engaging arrangement is mounted to a base of the unit and includes one of; a wheeled arrangement; a sliding arrangement

18. A unit as claimed in claim 13 wherein the cover is formed from Perspex™.

19. A unit as claimed in claim 14 wherein the cover is formed from Perspex™.
